(19) United States
(12) Patent Application Publication
(10) Pub. No.: US 2016/0090849 A1
(43) Pub. Date: Mar. 31, 2016

(54) FAN BLADE WITH STATIC DISSIPATIVE COATING

(71) Applicant: United Technologies Corporation, Farmington, CT (US)

(72) Inventors: Thomas J. Robertson, Glastonbury, CT (US); Scot A. Webb, Gales Ferry, CT (US)

(21) Appl. No.: 14/826,537

(22) Filed: Aug. 14, 2015

Related U.S. Application Data
(60) Provisional application No. 62/057,798, filed on Sep. 30, 2014.

(51) Int. Cl. F01D 5/28; F02C 3/04; F01D 5/32; F01D 5/02; F01D 5/30

(52) U.S. Cl. CPC F01D 5/288; F01D 5/02; F01D 5/3007; F01D 5/3092; F01D 5/326; F02C 3/04; F05D 2220/32; F05D 2240/30; F05D 2240/35; F05D 2300/611; F05D 2300/10; F05D 2300/224

(57) ABSTRACT

The present disclosure relates generally to a fan blade for use in a gas turbine engine, wherein the fan blade includes a metallic fan blade body, including a fan blade body leading edge and body outer surface, extending radially outward from a root, and a static dissipative coating material disposed on the body outer surface.

### CROSS REFERENCE TO RELATED APPLICATIONS

The present application is related to, and claims the priority benefit of, Provisional Application No. 62/057,798, filed Sep. 30, 2014, the contents of which are hereby incorporated in their entirety into the present disclosure.

### TECHNICAL FIELD OF THE DISCLOSED EMBODIMENTS

The present disclosure is generally related to gas turbine engines and, more specifically, a fan blade with static dissipative coating.

### BACKGROUND OF THE DISCLOSED EMBODIMENTS

Gas turbine engines are known, and typically include a fan delivering air into a compressor section. In the compressor section, the air is compressed and then delivered into a combustion section. The compressed air is mixed with fuel and burned in the combustion section. Products of this combustion pass downstream to drive turbine rotors.

The fan blades are subject to a large volume of air moving across an airfoil, and this can build up a large static electric charge if the air includes particulates, such as snow or dirt. Conventionally, the fan blades were formed of a conductive metal that was grounded to a hub that mounts the fan blade. As such, the charge would conduct into the hub.

More recently, fan blades have become larger. One factor driving the larger fan blades is the use of a gear reduction between a turbine driven spool which drives the fan blade and the spool. The gear reduction allows a single turbine rotor to drive both a compressor section and the fan, but at different speeds.

As the size of the fan blade has increased, its weight has also increased. As such, efforts have been made to reduce the weight of fan blades. One modification is to change the material for the fan blade from titanium to an aluminum alloy. The aluminum alloy fan blades are generally covered with a polyurethane coating and fabric wear pads to protect the aluminum. These materials have insulation qualities and, thus, the blade may not be electrically grounded to a rotor.

Improvements in the dissipation of a static charge on fan blades are therefore needed in the art.

### SUMMARY OF THE DISCLOSED EMBODIMENTS

In one aspect, a fan blade used in a gas turbine engine is provided. The fan blade includes a metallic fan blade body, including a body outer surface, the fan blade body extends radially outwardly from a dovetail or root. A fan blade body leading edge and a fan blade body trailing edge define the forward and rear limits of the metallic fan blade body. A static dissipative coating material is disposed on the body outer surface. In one embodiment, the static dissipative coating material is disposed on the root. In one embodiment, the static dissipative coating includes a paracrystalline material. In one embodiment, the paracrystalline material includes carbon black.

In one embodiment, the fan blade further includes a metallic fan blade leading edge sheath operably coupled to the fan blade body leading edge. The static dissipative coating material is in contact with the fan blade leading edge sheath to aid in the dissipation of a static electric charge that builds on the fan blade as it rotates.

In one embodiment, a grounding component is operably coupled to the leading edge of the root. In one embodiment, at least one non-conductive pad is disposed around at least a portion of the root 106 and the at least one non-conductive pad is in contact with the grounding component.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a sectional view of one example of a turbine engine in which the presently disclosed embodiments may be used;

FIG. 2 is a perspective view of a fan blade in an embodiment; and

FIG. 3 is a perspective view of a fan blade inserted into a fan rotor in an embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

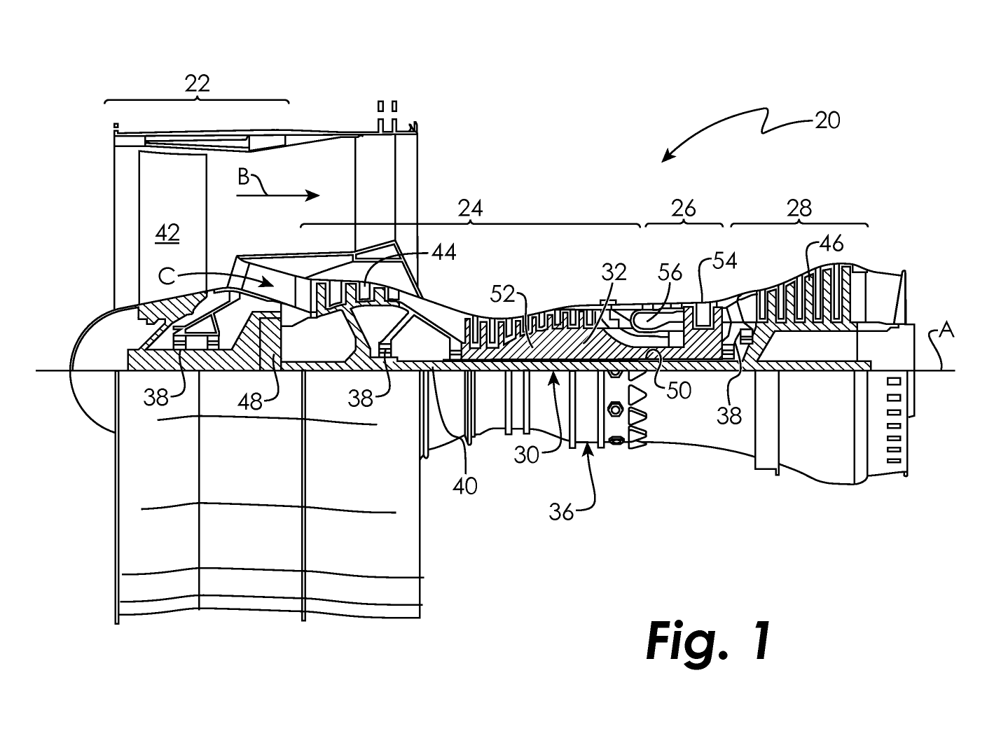

FIG. 1 shows a gas turbine engine 20, such as a gas turbine used for power generation or propulsion, circumferentially disposed about an engine centerline, or axial centerline axis A. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft. (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

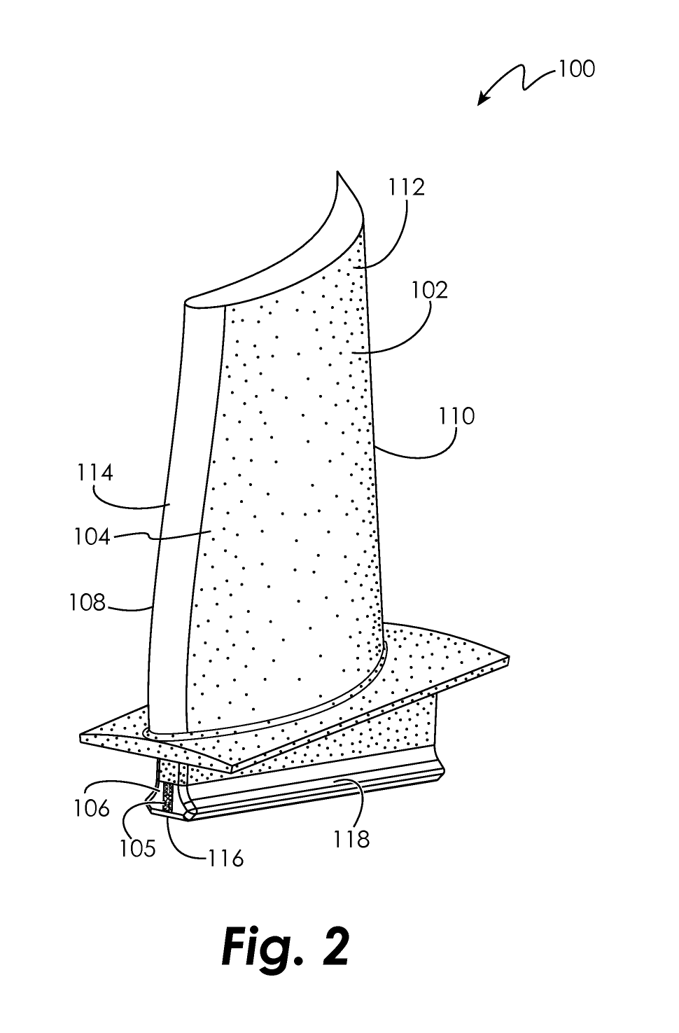

Referring to FIG. 2, a fan blade 100 may be used in an engine such as the engine 20. The fan blade 100 includes a metallic fan blade body 102, including a body outer surface 104, the fan blade body 102 extends radially outwardly from a dovetail or root 106. A fan blade body leading edge 108 and a fan blade body trailing edge 110 define the forward and rear limits of the metallic fan blade body 102. It will be appreciated that the metallic fan blade body may be formed from aluminum or aluminum alloys to name a couple of non-limiting examples. A static dissipative coating material 112 is disposed on the body outer surface 104, wherein the static dissipative coating 112 includes a paracrystalline material. The static dissipative coating material 112 may be composed of a urethane to name one non-limiting example; however, other dissipative materials such as those described in MIL-HDBK-263B may be used. In one embodiment, the static dissipative coating material is disposed on the root 106. In one embodiment, the paracrystalline material includes carbon black. It will also be appreciated that a conductive material coating may be disposed on the body outer surface.

In one embodiment, the fan blade 100 further includes a metallic fan blade leading edge sheath 114 operably coupled to the fan blade body leading edge 108. The metallic fan blade leading edge sheath 114 may be formed from a conductive material, such as titanium or a titanium alloy to name a couple of non-limiting examples. The static dissipative coating material 112 is in contact with the fan blade leading edge sheath 114 to aid in the dissipation of a static electric charge that builds on the fan blade 100 as it rotates.

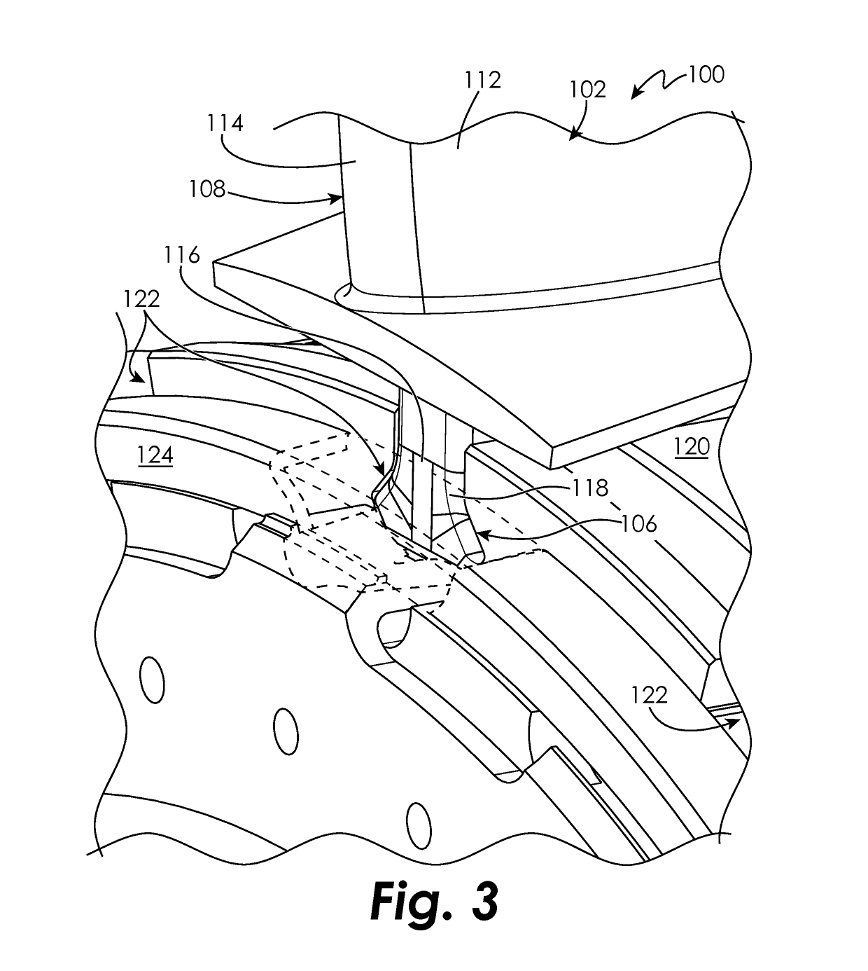

In one embodiment, a grounding component 116 is operably coupled to the leading edge 105 of the root 106. The grounding component 116 may be composed of an electrically conductive material, such as titanium or a titanium alloy to name a couple of non-limiting examples. The grounding component 116 may be coupled to the leading edge 105 of the root 106 via an adhesive, to name one non-limiting example. The grounding component 116 is configured to aid in the dissipation of a static electric charge from the metallic fan blade body to a lock ring 124; then, to a fan hub 120 (shown in FIG. 3)

In one embodiment, at least one non-conductive pad 118 is disposed around at least a portion of the root 106 and the at least one non-conductive pad 118 is in contact with the grounding component 116. The at least one non-conductive pad 118 is configured to ensure galvanic isolation between the metallic fan blade body 102 and the fan rotor 120 (shown in FIG. 3)

Referring to FIG. 3, a fan hub 120 receives the root 106 in a slot 122 to mount the fan blade 100 with the metallic fan blade body 102 extending radially outwardly. A lock ring 124 locks the fan blade 100 within the fan hub 120. As the fan hub 120 is driven to rotate, it carries the fan blade 100 with it. The lock ring 124 abuts the leading edge 105 of the root 106, and is also in contact with the grounding component 116.

It will be appreciated that as the fan hub 120 rotates and static charge builds on the fan blade 100, the static dissipative coating material 112 allows for discharge of the static charge while also preventing galvanic action between adjacent components, such as the fan blade leading edge sheath 114 and the metallic fan blade body 102.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A fan blade for a gas turbine engine comprising:
a metallic fan blade body, including a fan blade body leading edge and a fan blade body outer surface, the fan blade body extending radially outward from a root including a root leading edge; and
a static dissipative coating material disposed on the body outer surface.

2. The fan blade of claim 1, wherein the static dissipative coating material includes a paracrystalline material.

3. The fan blade of claim 1, further comprising a metallic fan blade leading edge sheath operably coupled to fan blade body leading edge, wherein the static dissipative coating material is in contact with the metallic fan blade leading edge sheath.

4. The fan blade of claim 1, wherein the static dissipative coating material is disposed on the root.

5. The fan blade of claim 1, further comprising a grounding component operably coupled to the root leading edge.

6. The fan blade of claim 1, wherein the paracrystalline material comprises carbon black.

7. The fan blade of claim 5, further comprising at least one non-conductive pad disposed around at least a portion of the root and in contact with the grounding component.

8. A fan assembly for use in a gas turbine engine comprising:
a rotor including at least one slot configured to receive a fan blade and a locking ring configured to secure the fan blade; and
a fan blade disposed within the at least one slot, wherein the fan blade comprises:
a metallic fan blade body, including a fan blade body leading edge and a fan blade body outer surface, the fan blade body extending radially outward from a root including a root leading edge; and
a static dissipative coating material disposed on the body outer surface

9. The fan assembly of claim 8, wherein the static dissipative coating material includes a paracrystalline material.

10. The fan assembly of claim 8, wherein the fan blade further comprises a metallic fan blade leading edge sheath operably coupled to the fan blade body leading edge, wherein the static dissipative coating material is in contact with the metallic fan blade leading edge sheath.

11. The fan assembly of claim 8, wherein the static dissipative coating material is disposed on the root.

12. The fan assembly of claim 8, further comprising a grounding component operably coupled to the root leading edge.

13. The fan assembly of claim 8, wherein the paracrystalline material comprises carbon black.

14. The fan assembly of claim 12, further comprising at least one non-conductive pad disposed around the root and in contact with the grounding component.

15. A gas turbine engine comprising:
a compressor section, a combustor section, and a turbine section in serial flow communication;
a fan section configured to deliver air into the compressor section, wherein the fan section comprises a rotor including at least one slot, a locking ring, and a fan blade disposed within the at least one slot, wherein the fan blade comprises:
a metallic fan blade body, including a fan blade body leading edge and a fan blade body outer surface, the fan blade body extending radially outward from a root including a root leading edge; and
a static dissipative coating material disposed on the body outer surface.

16. The gas turbine engine of claim 15, wherein the static dissipative coating material includes a paracrystalline material.

17. The gas turbine engine of claim 15, wherein the fan blade further comprises a metallic fan blade leading edge sheath operably coupled to the fan blade body leading edge, wherein the static dissipative coating material is in contact with the metallic fan blade leading edge sheath.

18. The gas turbine engine of claim 15, wherein the static dissipative coating material is disposed on the root.

19. The gas turbine engine of claim 15, further comprising a grounding component operably coupled to the root leading edge.

20. The gas turbine engine of claim 15, wherein the paracrystalline material comprises carbon black.

21. The gas turbine engine of claim 19, further comprising at least one non-conductive pad disposed around the root and in contact with the grounding component.
